(19) United States
(12) Patent Application Publication
(10) Pub. No.: US 2017/0335991 A1
(43) Pub. Date: Nov. 23, 2017

(54) VALVE OPERATOR ASSEMBLY WITH FREEWHEEL AND FRICTION MEANS

(71) Applicant: AKTIEBOLAGET SKF, Goteborg (SE)

(72) Inventors: Jérôme DUBUS, La Riche (FR); Marcus LEE, Houston, TX (US); Christian BOCH, Bassens (FR)

(73) Assignee: AKTIEBOLAGET SKF, Goteborg (SE)

(21) Appl. No.: 15/159,800

(22) Filed: May 20, 2016

(51) Int. Cl. F16K 31/50; F16K 3/02

(52) U.S. Cl. CPC F16K 31/508; F16K 3/0254

(57) ABSTRACT

The valve operator assembly is provided for a valve and comprises a housing 18, an input member 20 rotatably mounted, and a transmission mechanism 22 comprising a translating element 24 and a rotating element 28 connected to the input member, said transmission mechanism being adapted to convert applied rotation of the input member into axial translation of said translating element.

The assembly further comprises at least one locking mechanism 23 radially interposed between the transmission mechanism 22 and the housing 18, and provided with friction means 82 freely movable in circumferential direction relative to the transmission mechanism and to the housing and with one freewheel 80 comprising a plurality of locking members mounted in radial contact with a track of said friction means, the freewheel and the friction means cooperating together to lock the transmission mechanism 22 with the housing 18 in a static position of said assembly.

The present invention relates to the fields of valves and manually operable valves, for instance gate valves, control or regulation valves or chokes valves. More particularly, the invention relates to a valve operator assembly for a gate valve.

Valves are used in a variety of industries to control the flow of fluids. In particular, gate valves are used extensively in the oil and gas industry to control the flow of produced fluids at various stages of production. Most gate valves used in this industry comprise a valve body having a longitudinal flow bore and a transverse gate cavity that intersects the flow bore. A gate having a gate opening extending transversely therethrough is disposed in the gate cavity. A valve stem is provided for moving the gate between an open position, in which the gate opening is aligned with the flow bore, and a closed position, in which the gate opening is offset from the flow bore. The gate cavity of the valve body is covered by a bonnet having an axial bore through which passes the valve stem.

Such a gate valve is associated to a valve operator assembly for selectively driving the valve stem up and down in order to close and open the gate valve. A gate valve may be manually actuated. In this case, the valve operator assembly generally comprises a transmission mechanism to convert the rotational motion of a hand-wheel into axial motion of the valve stem. To quickly open and close the gate valve with a minimum number of turns, the transmission mechanism may be a ball screw mechanism or a planetary roller screw mechanism in order to reduce the operating torque, for instance manual hand-wheel torque or powered with electric drive for surface valves or with remote operating vehicle (ROV) or electric actuation for subsea valves. For more details, it is possible for example to refer to the patent EP-B1-1 419 334 (SKF).

Since such a screw mechanism is susceptible to back-drive under fluid pressure, the gate valve can be inadvertently opened or closed. Such back-driving can not only cause problems with the desired flow regulation, but can also lead to injury to an operator, for example from being struck by the rotating hand-wheel.

Accordingly, a balance system is generally provided on the valve body of the gate valve to prevent a back-driving of the transmission mechanism with the force exerted by the fluid. Such system comprises a balance stem disposed on the valve body and which is exposed to fluid pressure to offset or balance the force exerted on the gate.

However, it is necessary to modify the design of the valve body to integrate such a balance system on the gate valve. This leads to a complex structure of the gate valve. Besides, the required space for the gate valve is significantly increased.

One aim of the present invention is to overcome these drawbacks.

It is a particular object of the present invention to provide a valve operator assembly for valve, for instance gate valve, control or regulation valve or choke valve, which is not reversible or back-driveable.

In one embodiment, the valve operator assembly is provided for a valve comprising a valve body and a valve translating member axially moveable. The assembly comprises a housing adapted to be mounted on the valve, an input member rotatably mounted with respect to said housing, and a transmission mechanism comprising a translating element adapted to be connected to the valve translating member of the valve and a rotating element connected to the input member. Said transmission mechanism is adapted to convert applied rotation of the input member into axial translation of said translating element. The assembly further comprises at least one locking mechanism radially interposed between the transmission mechanism and the housing. The locking mechanism is provided with friction means freely movable in circumferential direction relative to the transmission mechanism and to the housing and with at least one freewheel comprising a plurality of locking members mounted in radial contact with a track of said friction means. The freewheel and the friction means cooperate together to lock the transmission mechanism with the housing in a static position of said assembly.

Advantageously, the freewheel is arranged in such a way that, in the static position, the locking members are in a locked position in order to generate a braking torque opposite to a backdriving torque of the transmission mechanism.

In one preferred embodiment, the locking members are in the locked position when the input member rotates relative to the housing in the direction of the backdriving torque of the transmission mechanism. Preferably, the locking members switch and stay in an unlocked position when the input member rotates in the opposite direction of said backdriving torque.

In one preferred embodiment, the friction means are adapted to create a friction torque between said friction means and the housing, or the transmission mechanism, so that the total friction torque of the assembly is greater than or equal to the backdriving torque of said transmission mechanism. Advantageously, the friction means be adapted to create a friction torque greater than or equal to said backdriving torque.

The friction means may comprise a friction ring radially bearing against the transmission mechanism or the housing. The friction means may further comprise a support ring onto which is mounted the friction ring, the locking members being mounted radially in contact with said support ring.

In one embodiment, the freewheel is mounted on the transmission mechanism and the friction means radially surround said freewheel and radially bear against the housing. Alternatively, the friction means radially bear against the transmission mechanism and the freewheel radially surrounds said friction means and comes into radial contact with the housing.

The transmission mechanism may further comprise an adapter sleeve connected to the rotating element of said mechanism and onto which is mounted the input member.

In one embodiment, the locking mechanism is mounted between the rotating element of the transmission mechanism and the housing. Alternatively, the locking mechanism may be mounted between the adapter sleeve and the housing.

In one embodiment, the transmission mechanism comprises a screw, a nut surrounding and coaxial with said screw, and a plurality of rolling elements radially disposed between the screw and the nut. Each rolling element may be engaged in both outer and inner threads provided on the screw and the nut.

In one embodiment, the screw forms the translating element and the nut is connected to the input member. Alternatively, the nut may form the translating element and the screw is connected to the input member.

Preferably, the valve operator assembly further comprises at least one rolling bearing radially disposed between the transmission mechanism and the housing.

The invention also relates to a valve, notably a gate valve, a control or regulation valve or a choke valve comprising a valve body, a valve translating member axially moveable and a valve operator assembly as previously defined. The valve translating member may be a valve stem or a piston for instance.

The present invention and its advantages will be better understood by studying the detailed description of specific embodiments given by way of non-limiting examples and illustrated by the appended drawings on which:

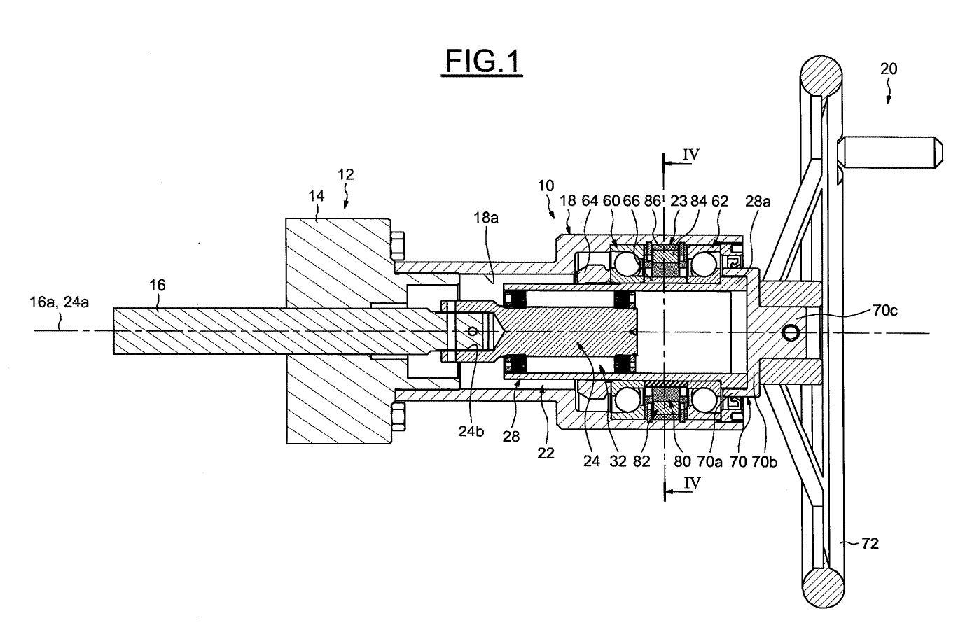

FIG. 1 is a cross-section of a valve operator assembly for gate valve according to a first example of the invention,

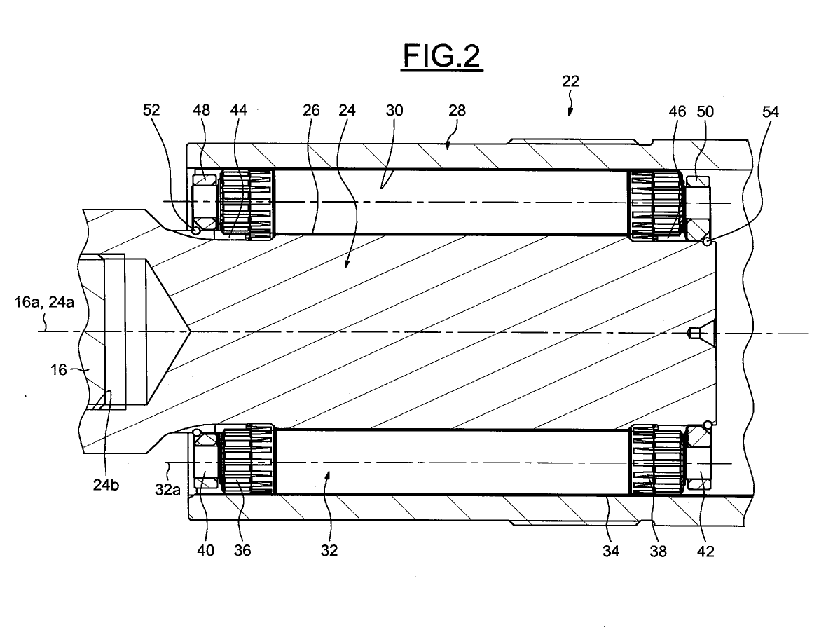

FIG. 2 is a cross-section of an inverted roller screw mechanism of the assembly of FIG. 1,

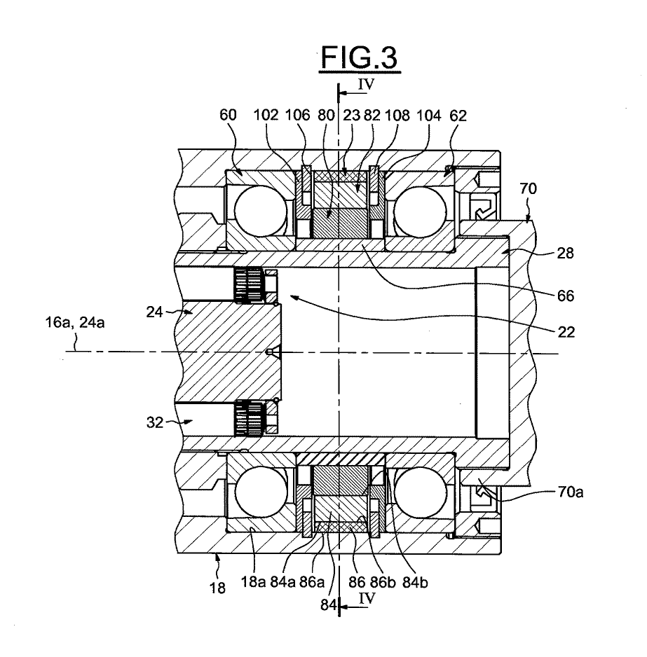

FIG. 3 is a detail view of FIG. 1,

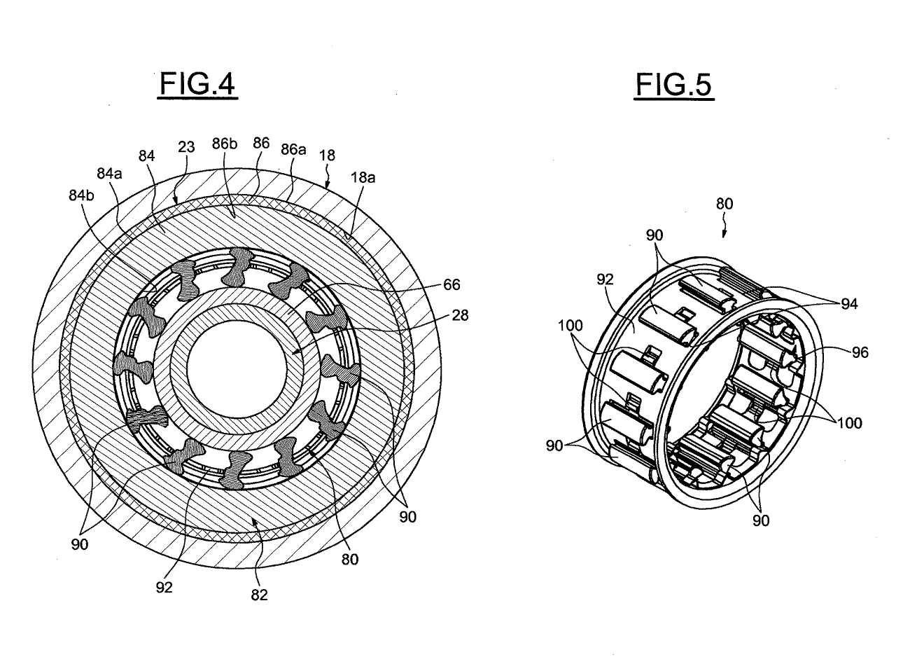

FIG. 4 is a section on IV-IV of FIG. 1,

FIG. 5 is a perspective view of a freewheel of the assembly of FIG. 1,

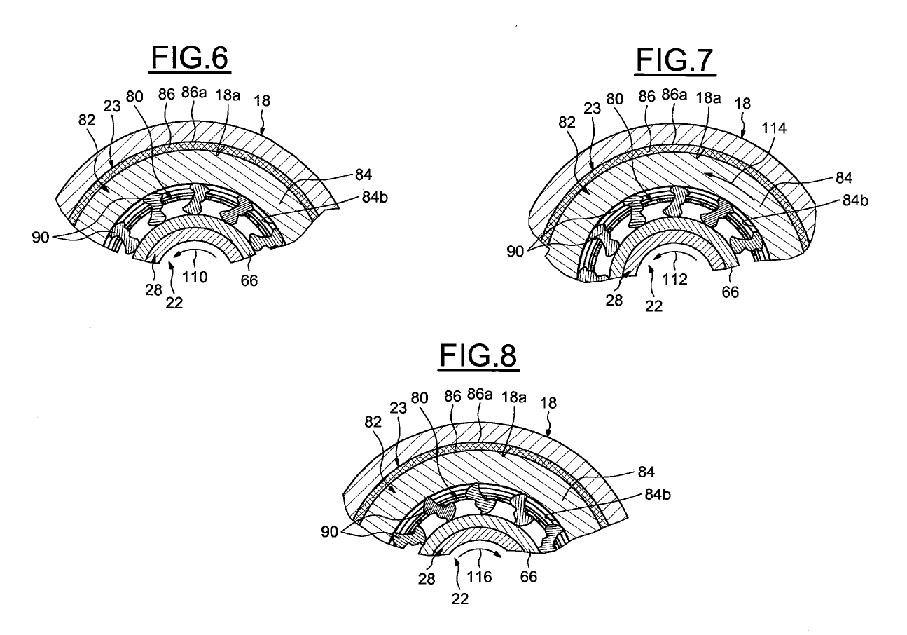

FIGS. 6 to 8 are partial sections on IV-IV of FIG. 1 according to a static position and two manipulating modes of the assembly,

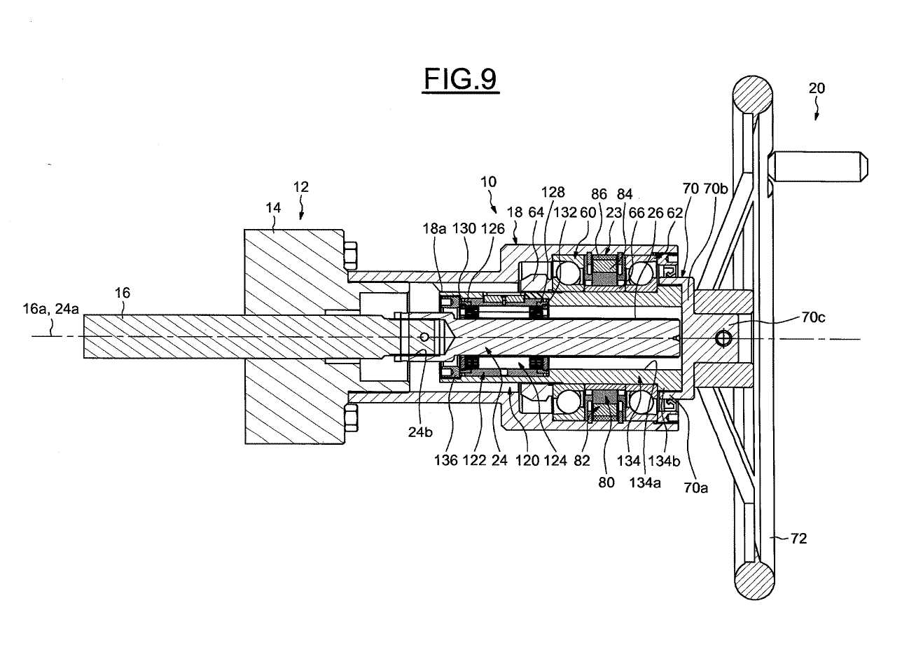

FIG. 9 is a cross-section of a valve operator assembly for gate valve according to a second example of the invention, and

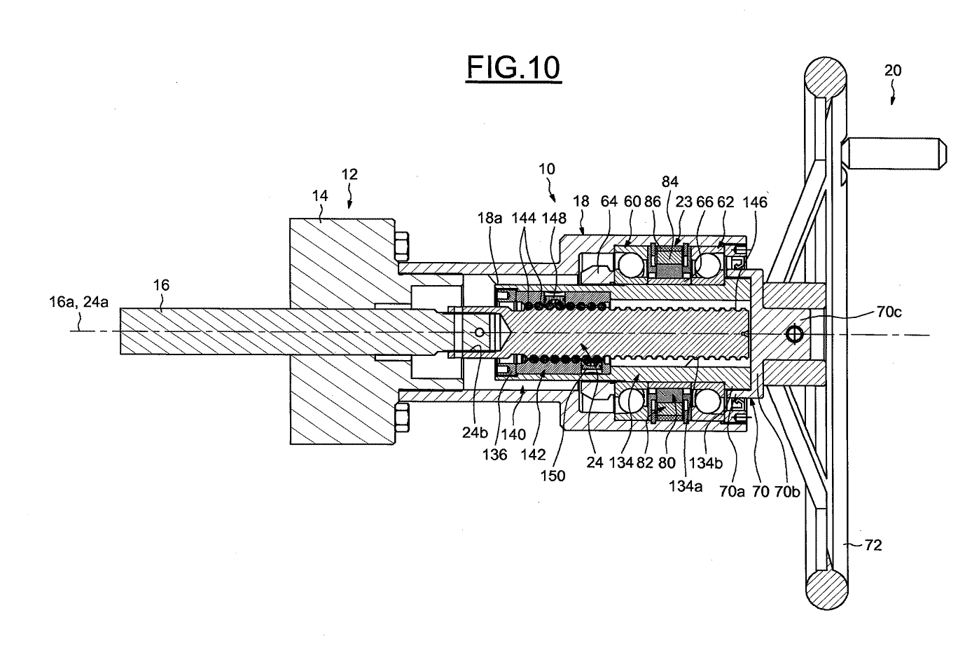

FIG. 10 is a cross-section of a valve operator assembly for gate valve according to a third example of the invention.

A valve operator assembly 10 as shown on FIG. 1 is adapted for a gate valve 12 provided with a bonnet 14, a valve body (not shown) covered by said bonnet and a moveable valve stem 16 with an axis 16a. Conventionally, the valve body has a flow bore and a transverse gate cavity that intersects the flow bore. The gate valve also comprises a gate having a gate opening extending transversely therethrough is disposed in the gate cavity. For more detail on such a gate valve, it could be referred to EP-B1-1 419 334 (SKF) which is hereby incorporated by reference.

The valve operator assembly 10 comprises a tubular housing 18 mounted on the bonnet 14 of the gate valve, an input member 20 rotatably mounted with respect to said housing, and an inverted roller screw mechanism 22 interposed between said input member and the valve stem 16 of said valve to convert a rotational motion of the input member 20 into axial motion of the valve stem. The inverted roller screw mechanism 22 is mounted into a bore 18a of the housing and is connected to the input member 20. One axial end of the housing 18 is secured to the bonnet 14 by threads (not referenced). In the illustrated example, the bore 18a has a stepped form.

As will be described later, the valve operator assembly 10 further comprises a locking mechanism 23 radially interposed between the housing 18 and the inverted roller screw mechanism 22 and adapted to prevent the back-driving of such mechanism under fluid pressure exerted on the valve stem 16.

As shown more clearly on FIG. 2, the inverted roller screw mechanism 22 comprises a screw 24, with an axis 24a coaxial with the axis 16a of the valve stem 16, provided with an outer thread 26, a nut 28 mounted coaxially about the screw 24 and provided with an inner thread 30, the internal diameter of which is greater than the external diameter of the outer thread 26, and a plurality of longitudinal rollers 32 disposed radially between the screw 24 and the nut 28.

The screw 24 extends longitudinally through a cylindrical bore of the nut 28 on which the inner thread 30 is formed. The nut 28 has a tubular form and is elongated to accommodate the full extent of screw travel. Axially on the side opposite to the input member 20 (FIG. 1), a recess 24b is formed on a frontal radial surface of the screw 24 and into which is fixed an end of the valve stem 16 of the gate valve. The valve stem 16 is connected to the screw 24 by any appropriate means, for example by threads and/or a pin.

The rollers 32 are identical to each other and are distributed regularly around the screw 24. Each roller 32 extends along an axis 32a which is coaxial with the axis 24a of the screw and comprises an outer thread 34 engaging the thread 26 of the screw and the thread 30 of the nut. Each roller 20 also comprises, at each axial end, outer gear teeth 36, 38 extending axially outwards the outer thread 34 and which are themselves extended axially by a cylindrical stud 40, 42 extending outwards. Each gear teeth 36, 38 are axially located between the associated stud 40, 42 and the outer thread 34. The outer thread 34 of each roller is axially located between the two gear teeth 36, 38.

The roller screw mechanism 22 also comprises two annular gear wheels 44, 46 provided on the outer surface of the screw 24 and each comprising outer gear teeth meshing the gear teeth 36, 38 respectively of the rollers 32 for the synchronization thereof. Each gear wheel 44, 46 is axially located near to an end of the outer thread 26 of the screw. Said outer thread 26 is axially located between the two gear wheels 44, 46. In the disclosed embodiment, the gear wheels 44, 46 are formed directly on the outer surface of the screw 24. Alternatively, the gear wheels may be separate parts which are fixed onto the screw 24.

The mechanism 22 further comprises two annular guides or spacer rings 48, 50 disposed on the outer surface of the screw 24. Said spacer rings 48, 50 are radially disposed between the screw 24 and the inner thread 30 of the nut without contact with said thread. Each spacer ring 48, 50 is mounted on the outer surface of the screw 24 axially next to the associated gear wheel 44, 46. Each spacer ring 48, 50 is axially offset towards the outside of the nut 28 with regard to the associated gear wheel 44, 46. Each spacer ring 48, 50 comprises a plurality of cylindrical through-recesses (not referenced) which are distributed regularly in the circumferential direction and inside which the studs 40, 42 of the rollers are housed. The spacer rings 48, 50 enable the rollers 32 to be carried and the regular circumferential spacing thereof to be kept. The mechanism 22 further comprises elastic retainer rings 52, 54 each mounted in a groove (not referenced) formed on the outer surface of the screw 24 in order to axially hold the corresponding spacer ring 48, 50.

Referring once again to FIG. 1, the roller screw mechanism 22 further comprises an adapter sleeve 70 mounted on the nut 28. The sleeve 70 comprises an annular axial portion 70a secured to the flange 28a of the nut by any appropriate means, for example by threads, a radial portion 70b extending radially inwards said axial portion 70a and bearing axially against the end of the nut, and a pin 70c projecting axially outwards from said radial portion 70b. Sealing means (not referenced) are provided between the axial portion 70a of the sleeve and the bore of the housing 18. In the illustrated example, the input member 20 comprises an operable hand-wheel 72 secured to the sleeve 70. The hand-wheel 72 is here secured onto the pin 70c of the sleeve. Said hand-wheel forms a rotational drive input.

The valve operator assembly 10 further comprises two rolling bearings 60, 62 to guide the rotation of the nut 28 of the inverted roller screw mechanism relative to the housing 18. The rolling bearings 60, 62 are radially mounted between the outer surface of the nut 28 and the stepped bore 18a of the housing. The rolling bearings 60, 62 are mounted radially in contact with the outer surface of the nut 28 and a large diameter portion of the stepped bore 18a of the housing. In the disclosed example, the rolling bearings 60, 62 are angular contact thrust ball bearings and are spaced apart axially one to another. A retaining ring 64 is secured on the outer surface of the nut 28 and axially bears against the rolling bearing 60. Axially on the opposite side, the rolling bearing 62 is axially mounted against a flange 28a of the nut 28 extending radially outwards the outer surface of said nut. The flange 28a is axially located at an axial end of the nut. The assembly 10 further comprises an annular sleeve 66 secured on the outer surface of the nut 28. The sleeve 66 axially bears at one end against the inner ring of the rolling bearing 60 and, at the opposite axial end, against the other rolling bearing 62.

In the illustrated example, the locking mechanism 23 is located axially between the rolling bearings 60, 62. The locking mechanism 23 is coaxial with the axis 24a of the screw. The locking mechanism 23 is radially disposed between the sleeve 66 secured to the nut 28 of the inverted roller screw mechanism and the housing 18. The locking mechanism 23 comes into radial contact with the nut 28 and with the housing 18. A “radial contact” is to be understood as a direct radial contact with the transmission mechanism 22 or with the housing 18, or as an indirect radial contact with the transmission mechanism 22 or with the housing 18 by means of a part fixed onto said transmission mechanism or housing.

As shown more clearly on FIG. 3, the locking mechanism 23 comprises a one-way clutch or freewheel 80 (schematically illustrated) and friction means 82 cooperating with the freewheel and radially interposed between said freewheel and the housing 18. The freewheel 80 is distinct from the friction means 82. The friction means 82 radially surround the freewheel 80.

The friction means 82 are mounted freely movable in the circumferential direction relative to the transmission mechanism 22, to the housing 18 and to the freewheel 80. The friction means 82 are frictionally engaged with the housing 18 and the freewheel 80.

In the illustrated example, the friction means 82 comprise a support ring 84 and a friction ring 86 mounted onto said support ring. The friction ring 86 is secured to the support ring 84 by any appropriate means. The support ring 84 is radially disposed between the friction ring 86 and the freewheel 80. The support ring 84 has an annular form and is provided with a cylindrical outer surface 84a mounted in radial contact with the friction ring 86 and with an opposite cylindrical bore 84b in sliding contact with the freewheel 80. For example, the support ring 84 may be made from metal. The support ring 84 further comprises two opposite radial lateral surfaces (not referenced) which axially delimit the outer surface 84a and the bore 84b.

As will be described later, the friction ring 86 is adapted to create a friction torque between the friction means 82 and the housing 18 so that the total friction torque of the assembly 10 is greater than or equal to the backdriving torque of the transmission mechanism 22. The friction ring 86 is disposed radially between the housing 18 and the support ring 84. The friction ring 86 has an annular form and is frictionally engaged with the housing 18 and with the freewheel 80. The friction ring 86 is provided with a cylindrical outer surface 86a mounted in radial contact with the bore 18a of the housing and with an opposite cylindrical bore 88b mounted on the outer surface 84a of the support ring 84. The friction ring 86 further comprises two opposite radial lateral surfaces (not referenced) which axially delimit the outer surface 86a and the bore 86b. In the illustrated example, the lateral surfaces of the friction ring 86 are respectively coplanar with the lateral frontal surfaces of the support ring 84. The friction ring 86 may be made from metal or from plastic material.

As shown on FIGS. 4 and 5, the freewheel 80 comprises a plurality of wedging cams or sprags 90 and an annular cage 92 for retaining said sprags. The sprags 90 are disposed between outer and inner sliding tracks or raceways which are respectively formed by the friction means 82 and the sleeve 66 secured to the nut 28 of the transmission mechanism 22. More precisely, the outer sliding raceway is formed by the bore of the support ring 84 and the inner sliding raceway is formed by the outer surface of the sleeve 66. Alternatively, it could be possible to not foresee such a sleeve 66. In this case, the sprags are directly mounted into contact with the nut 28. The sprags 90 are movable between a locked position together with the nut 28 and the friction means 82, and an unlocked or released position. In the illustrated example, the sprags 90 are axisymmetric in shape.

The cage 92 comprises a plurality of windows or pockets 94 for the sprags 90. The pockets 94 are evenly spaced relative to one another in the circumferential direction. There is no contact between the cage 92 and the transmission mechanism 22. The cage 92 of annular overall shape may be advantageously formed from a thin metal sheet blank by folding, cutting and stamping, or alternatively from a synthetic material such as a polyamide.

The freewheel 80 further comprises a spring 96 mounted inside the cage 92 in radial contact with the bore of said cage. The spring 96 is made in the form of an annular metal strip wound on itself and connected end-to-end or with partial overlap. The spring 96 may be formed for example from a thin metal sheet blank by folding, cutting and stamping, or else by moulding a synthetic material such as polyamide.

The spring 96 comprises a plurality of cavities or pockets (not referenced) which are uniformly circumferentially spaced relative to one another and face the pockets 94 of the cage in order to be able to mount the sprags 90. The spring 96 also comprises at least one elastic return tongue 100 per sprag 90 originating from the edge of a pocket and projecting circumferentially into said pocket for urging the associated sprag 90. Each tongue 100 is designed to press against the associated sprag 90 so as to exert a tilting torque that tends to keep the sprags 90 in contact with the outer and inner sliding raceways. The tongues 100 are identical each other and disposed between the cage 92 and the sprags 90. As a variant, it would be possible to provide an individual return element associated with each sprag, for example an elastic return spring placed between the sprag 90 and the cage 92.

Referring once again to FIG. 3, the valve operator assembly 10 further comprises two guiding flanges 102, 104 for the freewheel 80 each mounted in axial contact against the outer ring of one of the rolling bearings 60, 62. The guiding flanges 102 and 104, extends axially towards the freewheel 80 while remaining distant from the latter. Two circlips 106, 108 are each axially located between the freewheel 80 and one of the guiding flanges 102, 104 and axially bear against the associated guiding flange.

In a static position of the valve operator assembly 10 as shown on FIG. 6, i.e. when no torque is applied on the hand-wheel, only a fluid pressure is exerted both on the valve stem and the screw of the transmission mechanism. The backdriving torque of the transmission mechanism 22 which is susceptible to occur under fluid pressure is illustrated on FIG. 6 by the arrow 110. In the illustrated example, said backdriving torque is oriented in the counterclockwise direction. The freewheel 80 is mounted in such a way that, in the static position, the sprags 90 are in the locked position between the nut 28 of the transmission mechanism and the friction means 82 in order to generate a braking torque having a direction opposite to the one of the backdriving torque. The outer surface 86a of the friction ring 86 creates a predetermined friction torque between the friction means 82 and the housing 18 so that the total friction torque of the assembly 10 is greater than or equal to the backdriving torque of the transmission mechanism 22. Advantageously, the friction ring 86 creates a friction torque which is greater than or equal to said backdriving torque. There is no angular movement of the friction means 82 relative to the housing 18 under fluid pressure. The material of the friction ring 86 and/or its length are determined in order to obtain the desired friction torque. In addition, the friction ring 88 may be pushed by the freewheel 80 by means of the support ring made in this case deformable in radial direction. Accordingly, the freewheel 80 may create an additional force on the friction ring 88 which increases the friction torque.

In the static position of the assembly 10, the friction means 82 are locked in rotation on the inner side by the freewheel 80. There is no relative angular movement between the friction means 82 and the freewheel 80. Besides, the friction torque between the friction means 82 and the housing 18 prevents a relative angular movement between these two elements. Accordingly, the nut 28 of the transmission mechanism is secured or locked with the fixed housing 18. The locking mechanism 23 acts as coupling means frictionally engage with the transmission mechanism 22 and the housing 18 so as to prevent a relative circumferential movement therebetween.

In a static position of the valve operator assembly 10, the prevention of the back-driving of the inverted roller screw mechanism 22 is guaranteed. The backdriving is not guaranteed by the roller screw mechanism 22 itself but by the assembly 10 comprising said mechanism and surrounding components including the freewheel 80 and the friction means 82. Under fluid pressure exerted both on the valve stem 16 and the screw 24, the mechanism 22 is not reversible or back-driveable. The force exerted by the fluid is not transformed into an angular displacement of the nut 28 relative to the housing 18. Accordingly, it is possible to not foresee a balance system, such as a balance stem, on the valve body of the gate valve. Even with balanced design, the valve operator may also be used if the balance stem cannot fully balance the pressure in closed or open position. In this case, the small unbalance that may exist could be locked.

When an operator applies a torque on the hand-wheel 72 in the direction according to which the force exerted by the fluid on the valve stem 16 of the valve gate helps the axial movement of the screw 24, the freewheel 80 remains in the locked position between the nut 28 of the transmission mechanism and the friction means 82. The operating torque is applied in the same direction as the backdriving torque of the transmission mechanism 22. On FIG. 7, the operating torque is illustrated by the arrow 112. When the input member 20 rotates in the direction of the backdriving torque 110, the freewheel 80 is in the locked position.

When the manipulating torque 112 applied by the operator is greater than the friction torque between the friction means 82 and the housing 18 together with the useful torque to actuate the gate valve, both the nut 28 of the inverted roller screw mechanism and the friction means 82 rotate in the same direction relative to the housing 18 as illustrated by the arrow 114. With the rotation of the nut 28, the rollers 32 rotate on themselves about the screw 24 and move axially and additionally rotate in the nut 28. The rollers 32 are rotationally guided by outer gear wheels 44, 46 provided on the screw and meshing with the gear teeth of the rollers. Both the rollers 32 and the screw 24 are axially or longitudinally moveable into the nut 28. Accordingly, the rotational motion of a hand-wheel 72 is converted into an axial motion of the valve stem 16 of the valve gate.

The sliding of the friction means 82 on the housing 18 generates a torque which increases the required torque on the hand-wheel 72 but in an affordable way since the force exerted by the fluid on the valve stem 16 of the valve gate helps to reduce the force on the screw 24 and then helps the displacement of said screw.

When the operator applies an opposite torque on the hand-wheel as illustrated by the arrow 116 on FIG. 8, the sprags 90 pivot or tilt in the opposite direction, which causes the unlocking or freeing of said sprags. With said applied torque, the freewheel 80 switches in the unlocked position between the nut 28 of the transmission mechanism and the friction means 82. The nut 28 of the inverted roller screw mechanism rotates relative to the freewheel 80, to the friction means 82 and to the housing 18 since the drag torque of said freewheel is smaller than the friction torque between the friction means 82 and the housing 18. An angular movement of the friction means 82 relative to the housing 18 and to the freewheel 80 is prevented.

In this case, the angular displacement of the hand-wheel 72 is converted into an axial motion of the valve stem 16 of the valve gate in the direction opposite to the pressure direction. The required torque on the hand-wheel 72 is limited to the useful torque to actuate the gate valve 12 together with the drag torque of the freewheel 80. Accordingly, with the use of the freewheel 80, it is not necessary to apply an extra torque to counter the friction torque exerted by the friction means 82. When the operator do not apply anymore a torque in the opposite direction of the backdriving torque, the freewheel 80 switches in the locked position.

In the valve operator assembly 10, the freewheel 80 cooperates with the friction means 82 to block the transmission mechanism 22 together with the fixed housing 18 when no torque is applied on the input member 20, i.e. when said input member remains at a particular angular position with regard to the housing 18. In such static position, the transmission mechanism 22 is rigidly connected to the housing 18 by the locking action of the freewheel 80 and the friction between the friction means 82 and the housing 18. The transmission mechanism 22 is rigidly locked with the housing 18 to prevent a back-driving movement of said mechanism with the force exerted by the fluid on the screw 24. In the static position of the assembly 10, the locking mechanism 23 forms coupling means between the transmission mechanism 22 and the housing 18.

Besides, the freewheel 80 of the locking mechanism enables to limit the required torque on the input member 20 to actuate the screw 24 of the transmission mechanism and the valve stem 16 of the valve gate in the direction opposite to the force exerted by the fluid. As a matter of fact, in this case, an angular movement of the friction means 82 relative to the housing 18 is prevented.

In this first illustrated example, the invention has been illustrated on the basis of a valve operator assembly 10 for gate valve comprising an inverted roller screw mechanism 22. This leads to a high load capacity of the assembly 10 since the inverted roller screw mechanism thread geometry can be larger than with other type of roller screw mechanism since there is no minimum number of starts required. This increases load capacity while keeping compactness advantage. Additionally, smaller lead will help to reduce drive torque. Consequently, the backdriving torque will be reduced. The lifetime of the assembly 10 is also increased. Otherwise, the required space for the assembly 10 is reduced.

However, the invention can also be applied to a valve operator assembly having other type of roller screw mechanism such as standard planetary roller screw mechanism as shown on FIG. 9.

In this second example, in which identical parts are given identical references, the valve operator assembly 10 is provided with a planetary roller screw mechanism 120 interposed between the input member 20 and the valve stem 16 of the valve gate and which comprises a nut 122 mounted coaxially about the screw 24 and provided with an inner thread, and a plurality of identical rollers 124 disposed radially between the screw 24 and the nut 122 and having a design similar to the one of the inverted roller screw mechanism as previously described. In this example, the outer thread 26 of the screw 24 has an elongated length.

The mechanism 120 also comprises two annular gear wheels 126, 128 mounted in a non-threaded part of the nut 122 and each comprising inner gear teeth meshing the gear teeth of the rollers 124 for the synchronization thereof. Each gear wheel 126, 128 axially bears against a radial surface of the nut 122 provided between the inner thread and the associated non-threaded part of said nut.

The mechanism 120 further comprises two spacer rings 130, 132 each mounted radially between the screw 24 and the associated gear wheel 126, 128, and elastic retainer rings (not referenced) each mounted in a groove formed on the bore of the associated gear wheel 126, 128 in order to axially hold the corresponding spacer ring 130, 132. Each spacer ring 130, 132 is provided with a plurality of axial through-holes inside which the studs of the rollers 124 are housed.

The mechanism 120 also comprises an outer sleeve 134 having an axial bore 134a having a stepped form and inside which are housed the nut 122 and the rollers 124. The nut 122 is secured to the sleeve 134. The gear wheel 128 axially bears against a radial annular shoulder of the stepped bore 134a of the nut. Axially on the opposite side, a retaining ring 136 is secured into said bore and axially comes into contact against the other gear wheel 126 of the mechanism.

The rolling bearings 60, 62 and the locking mechanism 23 are mounted on the outer surface of the sleeve 134. The sleeve 134 is radially interposed between the nut 122 on the one hand and the rolling bearings 60, 62 and the locking mechanism 23 on the other hand. The rolling bearing 62 is axially mounted against a flange 134b of the sleeve extending radially outwards the outer surface of said sleeve. The flange 134b is axially located at an axial end of the sleeve. In this example, the adapter sleeve 70 of the input member is secured to the flange 134b of the outer sleeve and axially bears against said flange. Alternatively, it could be possible to make the nut 122 and the sleeve 134 in one single part. In this case, the rolling bearings 60, 62 and the locking mechanism 23 are mounted directly on the outer surface of the nut.

When an operator applies a torque on the hand-wheel 72, this torque is transmitted to the adapter sleeve 70 and then to the outer sleeve 134 and the nut 122 of the planetary roller screw mechanism. With the rotation of the nut 122, the rollers 124 rotate on themselves and roll about the screw 24 without moving axially inside said nut. Accordingly, the screw 24 is axially or longitudinally moveable into the nut 122 and the rotational motion of a hand-wheel 72 is converted into an axial motion of the valve stem 16 of the valve gate. The locking mechanism 23 acts as previously described.

The two first illustrated examples respectively deal with an inverted roller screw mechanism and a standard planetary roller screw mechanism. The invention can also be applied to a valve operator assembly having other type of roller screw mechanism wherein the rollers are deprived of outer threads but have grooves into which are engaged the threads of the screw and the nut and axially move with respect to said screw and nut. After a complete revolution, each roller is returned to its initial position by cams provided at the ends of the nut. Such mechanism is called a recirculating roller screw and may be of the standard or inverted type.

In the third example illustrated on FIG. 10, in which identical parts are given identical references, the valve operator assembly 10 is provided with a standard ball screw mechanism 140 comprising a nut 142 mounted coaxially about the screw 24 and provided with an inner thread, and a plurality of identical balls 144 disposed radially between the screw 24 and the nut 142 and which engage the thread of said nut and the thread 146 of the screw. The nut 142 is mounted into the bore 134a of the outer sleeve 134 and axially bears against a radial annular shoulder of said bore. Axially on the opposite side, the retaining ring 136 is secured into the bore 134a of the outer sleeve and axially comes into contact against the nut 142. The nut 142 is secured to the outer sleeve 134. Alternatively, the nut 142 and the sleeve may be made in one part. The nut 142 comprises recirculating means 148, 150 mounted into its thickness to achieve the recirculation of the balls 144. Such mechanism is called a standard ball screw. Alternatively, recirculating means may be provided on the screw. Such mechanism is called an inverted ball screw.

Otherwise, the invention can also be applied to a valve operator assembly having other type of transmission mechanism adapted to convert a rotation into a linear movement, for instance a directed threaded connection. However, such transmission mechanism requires large actuation torques.

In the illustrated examples, the lock mechanism 23 is radially interposed between the housing 18 and the rotating nut of the transmission mechanism. Alternatively, the locking mechanism 23 may be interposed between the housing 18 and the sleeve 70 of the transmission mechanism. However, with such disposition, the axial required space of the assembly 10 is increased. In another variant, it also possible to dispose the locking mechanism 23 radially between the housing 18 and the rotating nut of the transmission mechanism and axially between the rolling bearings 62, 64 and the annular sleeve 70.

In the disclosed examples, the friction means 82 radially bear against the housing 18 and the freewheel 80 is radially interposed with contact between said friction means and the transmission mechanism 22. In a variant, it could be possible to have an inverted arrangement with friction means 82 radially bearing against the transmission mechanism 22 and with the freewheel 80 radially disposed between said friction ring and the housing 18. In this case, the freewheel 80 radially surrounds the friction means 82. However, with the arrangement of the locking mechanism 23 as shown on the Figures, the freewheel 80 is economic since its diameter is smaller and the friction ring 84 is simple to replace in case of excessive wear.

In the illustrated examples, the friction means comprise a friction ring 86 and a supporting ring 84. Alternatively, the friction means may only comprise a friction ring. In this case, the sprags of the freewheel bear directly on a track or raceway of the friction ring. In the illustrated examples, the freewheel comprises a plurality of sprags acting as locking members. Alternatively, other type of freewheel may be used for example a freewheel with locking rollers.

Although the invention has been illustrated on the basis of a valve operator comprising a screw connected to the valve stem of the gate and a nut connected to the input member, it should be understood that the invention can be applied with a screw connected to the input member and a nut connected to the valve stem. In this case, the nut acts as the translating element and the screw acts as the rotating element. Accordingly, the locking mechanism may be interposed between the screw and the housing. Although the invention has been illustrated on the basis of a valve operator assembly for gate valve, it should be understood that the invention can also be used with other types of valves, for instance control or regulation valves or choke valves. The valve operator assembly may be used for instance with a surface gate or a subsea valve gate which may be actuated by a remote operating vehicle (ROV) or an actuator.

1. Valve operator assembly for valve comprising a valve body and a valve translating member axially moveable, the assembly comprising a housing adapted to be mounted on the valve, an input member rotatably mounted with respect to said housing, and a transmission mechanism comprising a translating element adapted to be connected to the valve translating member of the valve and a rotating element connected to the input member, said transmission mechanism being adapted to convert applied rotation of the input member into axial translation of said translating element, characterized in that the assembly further comprises at least one locking mechanism radially interposed between the transmission mechanism and the housing, the locking mechanism being provided with friction means freely movable in circumferential direction relative to the transmission mechanism and to the housing and with at least one freewheel comprising a plurality of locking members mounted in radial contact with a track of said friction means, the freewheel and the friction means cooperating together to lock the transmission mechanism with the housing in a static position of said assembly.

2. Valve operator assembly according to claim 1, wherein the freewheel is arranged in such a way that, in the static position, the locking members are in a locked position in order to generate a braking torque opposite to a backdriving torque of the transmission mechanism.

3. Valve operator assembly according to claim 2, wherein the locking members are in the locked position when the input member rotates relative to the housing in the direction of the backdriving torque of the transmission mechanism and wherein the locking members switch in an unlocked position when the input member rotates in the opposite direction of said backdriving torque.

4. Valve operator assembly according to claim 1, wherein the friction means are adapted to create a friction torque between said friction means and the housing, or the transmission mechanism, so that the total friction torque of the assembly is greater than or equal to a backdriving torque of said transmission mechanism.

5. Valve operator according to claim 4, wherein the friction means are adapted to create a friction torque greater than or equal to said backdriving torque.

6. Valve operator assembly according to claim 1, wherein the friction means comprise a friction ring radially bearing against the transmission mechanism or the housing.

7. Valve operator assembly according to claim 6, wherein the friction means further comprise a support ring onto which is mounted the friction ring, the locking members being mounted radially in contact with said support ring.

8. Valve operator assembly according to claim 1, wherein the freewheel is mounted on the transmission mechanism and the friction means radially surround said freewheel and radially bear against the housing.

9. Valve operator assembly according to claim 1, wherein the friction means radially bear against the transmission mechanism and the freewheel radially surrounds said friction means and comes into radial contact with the housing.

10. Valve operator assembly according to claim 1, wherein the transmission mechanism further comprises an adapter sleeve connected to the rotating element of said mechanism and onto which is mounted the input member.

11. Valve operator assembly according to claim 10, wherein the locking mechanism is mounted between the adapter sleeve and the housing.

12. Valve operator assembly according to claim 1, wherein the locking mechanism is mounted between the rotating element of the transmission mechanism and the housing.

13. Valve operator assembly according to claim 1, wherein the transmission mechanism comprises a screw, a nut surrounding and coaxial with said screw, and a plurality of rolling elements radially disposed between the screw and the nut.

14. Valve operator assembly according to claim 13, wherein the screw forms the translating element and the nut forms the rotating element, or vice versa.

15. Valve operator assembly according to claim 1, further comprising at least one rolling bearing radially disposed between the transmission mechanism and the housing.

16. Valve comprising a valve body, a valve translating member axially moveable and a valve operator assembly for valve comprising a valve body and a valve translating member axially moveable, the assembly comprising a housing adapted to be mounted on the valve, an input member rotatably mounted with respect to said housing, and a transmission mechanism comprising a translating element adapted to be connected to the valve translating member of the valve and a rotating element connected to the input member, said transmission mechanism being adapted to convert applied rotation of the input member into axial translation of said translating element, characterized in that the assembly further comprises at least one locking mechanism radially interposed between the transmission mechanism and the housing, the locking mechanism being provided with friction means freely movable in circumferential direction relative to the transmission mechanism and to the housing and with at least one freewheel comprising a plurality of locking members mounted in radial contact with a track of said friction means, the freewheel and the friction means cooperating together to lock the transmission mechanism with the housing in a static position of said assembly.
